(19) United States
(12) Patent Application Publication
(10) Pub. No.: US 2012/0305178 A1
(43) Pub. Date: Dec. 6, 2012

(54) ANISOTROPIC ELECTRICALLY CONDUCTIVE ADHESIVE FILM AND METHOD FOR MANUFACTURING SAME

(75) Inventors: Minoru Nagashima, Kanuma-Shi (JP); Tadasu Kawashima, Kanuma-shi (JP)

(73) Assignee: SONY CHEMICAL & INFORMATION DEVICE CORPORATION, Tokyo (JP)

(21) Appl. No.: 13/491,130

(22) Filed: Jun. 7, 2012

Related U.S. Application Data
(62) Division of application No. 12/598,622, filed on Nov. 3, 2009.

(30) Foreign Application Priority Data
May 7, 2007 (JP) 2007-122783

(51) Int. Cl. B05D 5/12; B32B 38/04; B32B 37/12

(52) U.S. Cl. 156/267; 427/58; 156/60

(57) ABSTRACT

An anisotropic electrically conductive adhesive film for establishing electrically conductive interconnection between electronic components includes a first peel film having a first peel layer on its one surface, and an adhesive layer provided on the first peel film via the first peel layer. The adhesive layer is formed of an anisotropic electrically conductive adhesive material. The adhesive film also includes a second peel film having a second peel layer on its one surface. The second peel film is provided via the second peel layer on a surface of the adhesive layer opposite to the surface of the adhesive layer provided with the first peel film. The first and second peel films have a non-contractile biodegradable film composed of a fatty acid polyester component as a base material. The first and second peel layers formed of a thermosetting silicone resin curable are provided on each top of the base material.

### TECHNICAL FIELD

This invention relates to an anisotropic electrically conductive adhesive film for electrically conductively interconnecting a substrate and an electronic component. More particularly, it relates to an anisotropic electrically conductive adhesive film that uses a biodegradable film for its peel film, and a method for manufacturing the anisotropic electrically conductive adhesive film.

The present application is a National Stage Application of PCT Application No. PCT/JP2008/057779 filed on Apr. 22, 2008, which claims priority rights based on the Japanese Patent Application 2007-122783, filed in Japan on May 7, 2007. The total disclosure of the Patent Application of the senior filing date is to be incorporated herein by reference.

### BACKGROUND ART

In interconnecting a connection terminal of a semiconductor device and a connection terminal of a substrate therefor, it has so far been practiced to make anisotropic electrically conductive interconnection using an anisotropic electrically conductive adhesive film.

The so used anisotropic electrically conductive adhesive film includes a base material, which is to form a base film, a peel layer provided on the surface of the base material, an adhesive layer provided on the surface of the peel layer, and a cover film. This cover film is arranged on the surface of the adhesive layer via another peel layer.

In carrying out anisotropic electrically conductive interconnection using such anisotropic electrically conductive adhesive film, the cover film is initially peeled from the adhesive layer along with the other peel layer. The surface of the adhesive layer is then applied to a bond surface of a substrate, and the base film is then peeled along with the first-stated peel layer. This will leave the adhesive layer on the substrate. The adhesive layer is sandwiched between the substrate and a component to be bonded thereto, and a resulting assembly is pressured under heating. Thus, the substrate and the component may be bonded together having electrical conductivity.

The base film or the cover film composing the anisotropic electrically conductive adhesive film, is a peel film prepared by providing a coating film (peel layer) of a releasing agent on one surface of a peel base substrate, such as a polyester film. The base film or the cover film is also used widely as a protective film for a variety of adhesive coating films. In general, the anisotropic electrically conductive adhesive film is applied by coating a surface of a base film with a liquid coating material, containing a reactive adhesive and a solvent, followed by heating to eliminate the solvent. The peel film, which is to be a cover film, is applied to the surface of the adhesive coating film. Regarding the peel films used as the base film or the cover film, attempts are being made to recycle polyester of which the peel films are made. However, only part of the film products is now being recycled while most of them are discarded as industrial wastes.

It should be noted that bioplastics, including polylactic acid (PLA) as a most important instance, may be used in the same way as ordinary plastics products. In addition, they are decomposed after use into water and carbon dioxide by microorganisms or degrading enzymes in nature. That is, bioplastics are so-called ‘return-to-nature’ plastics. In disposal of wastes, they can be land-filled. If the bioplastics are burned, only a small amount of heat is generated while no harmful substances such as dioxin are released, thus significantly reducing the load otherwise imposed on the global environment. Thus, the bioplastics are stirring up notice as next-generation plastics, and are expected to be applied to a product used in natural environments or in a field where recycling after use is difficult. The bioplastics are also expected to be used as a peel film that constitutes the aforementioned electrically conductive adhesive film.

However, the bioplastics material currently used, inclusive of polylactic acid (PLA), as a most important instance, does not compare favorably with plastics derived from petroleum in regard to thermal resistance or shock resistance, even though the bioplastics material is attractive for environmental protection. Hence, the bioplastics material has not come into widespread use.

To cite an instance, in producing a peel film of an anisotropic electrically conductive adhesive film, it is necessary to heat-process a releasing agent composition applied on the surface of the base material in order to produce a peel layer. The base material needs to be cured on heating to ca. 100° C. to 130° C. During this heat processing, the base material of the commonplace bioplastics becomes deformed to appreciably detract from the performance as the peel film.

On the other hand, the anisotropic electrically conductive adhesive film is initially prepared in general as a film base material of a broader width. A peel layer and an adhesive layer are then applied to the film base material of the broader width, and a resulting assembly is cut or severed into a plurality of tapes of narrow widths, which are separately taken up on a reel to form an ultimate product. It is thus necessary that the film may readily be slit into tapes of smaller widths, that is, it has high sectility. However, the commonplace bioplastics are poor in sectility.

### DISCLOSURE OF THE INVENTION

### Problem to be solved by the Invention

It is an object of the present invention to provide an anisotropic electrically conductive adhesive film in which, when a biodegradable film is used as a base material for the peel film, it is possible to prevent the peel film from becoming deformed on heat processing, while it is possible to cut or sever the film with ease into a narrow width film. It is also envisaged by the present invention to provide a method for manufacturing the anisotropic electrically conductive adhesive film.

An anisotropic electrically conductive adhesive film according to the present invention comprises a peel film having a peel layer on its one surface, and an adhesive layer provided on the peel film via the peel layer. The adhesive layer is formed of an anisotropic electrically conductive adhesive material. The peel film has, as a base material, a non-contractile biodegradable film composed of a fatty acid polyester component. The peel layer formed of a thermosetting silicone resin, curable at a temperature not lower than 100° C., is provided on top of the base material.

Another anisotropic electrically conductive adhesive film according to the present invention comprises a first peel film having a first peel layer on its one surface, and an adhesive layer provided on the first peel film via the first peel layer. The adhesive layer is formed of an anisotropic electrically conductive adhesive material. The adhesive film also includes a second peel film having a second peel layer on its one surface. The second peel layer has a peel force different from that of the first peel layer. The second peel film is provided via a second peel layer on a surface of the adhesive layer opposite to the surface thereof which is provided with the first peel film. The first and second peel films have a non-contractile biodegradable film composed of a fatty acid polyester component as a base material. The first and second peel layers, formed of a thermosetting silicone resin curable at a temperature not lower than 100° C., are provided on each top of the base material.

A method for manufacturing an anisotropic electrically conductive adhesive film according to the present invention includes a first step of applying a thermosetting silicone resin liquid curable at a temperature not lower than 100° C., to provide a peel layer on a non-contractile biodegradable film. This non-contractile biodegradable film composed of a fatty acid polyester component, proves to be a base material of a peel film. The method also includes a second step of drying and thermally curing the silicone resin liquid at a temperature not lower than 100° C. to provide the peel film having the peel layer. The method further includes a third step of applying an anisotropic electrically conductive adhesive material on the peel layer, and a fourth step of drying the anisotropic electrically conductive adhesive material to form an adhesive layer.

Another method for manufacturing an anisotropic electrically conductive adhesive film according to the present invention includes a first step of applying a thermosetting silicone resin liquid, curable at a temperature not lower than 100° C., to provide a first and a second peel layers, on a non-contractile biodegradable film. This non-contractile biodegradable film, composed of a fatty acid polyester component, proves to be a base material of a first and a second peel films The method also includes a second step of drying and thermally curing the silicone resin liquid at a temperature not lower than 100° C. to form a first peel film having a first peel layer and a second peel film having a second peel layer having a peel force different from that of the first layer. The method also includes a third step of applying an anisotropic electrically conductive adhesive material on the first peel layer of the first peel film. The method further includes a fourth step of drying the anisotropic electrically conductive adhesive material to form an adhesive layer, and a fifth step of layering the second peel film via the second peel layer on a surface of the adhesive layer opposite to the surface thereof which is provided with the first peel film.

With the anisotropic electrically conductive adhesive film, in which a biodegradable film is used as a base material of the peel film, it is possible to relieve the load otherwise imposed on the global environment. In addition, it is possible to prevent the film from becoming deformed at the time of heat treatment as well as to develop optimum sectility by using non-contractile biodegradable film composed of a fatty acid polyester component.

Other objects and advantages of the present invention will become more apparent from the following description of the invention especially when read in conjunction with the accompanying drawings.

### BRIEF DESCRIPTION OF THE DRAWINGS

FIG. 1 is cross-sectional view of an example of an anisotropic electrically conductive adhesive film according to the present invention.

FIG. 2 is a graph showing measurement results of DSC (Differential Scanning Calorimetry) in case of cooling an L polylactic acid, added by 3 wt % of D polylactic acid, at a rate of 1° C./min from a molten state.

FIG. 3 is cross-sectional view of another example of an anisotropic electrically conductive adhesive film according to the present invention.

### BEST MODE FOR CARRYING OUT THE INVENTION

An anisotropic electrically conductive adhesive film according to the present invention will now be described in detail with reference to the drawings.

The anisotropic electrically conductive adhesive film 1 according to the present invention may be used to interconnect a substrate and an electronic component carrying a pattern of electrodes thereon, and to bond them together as have electrical conductivity.

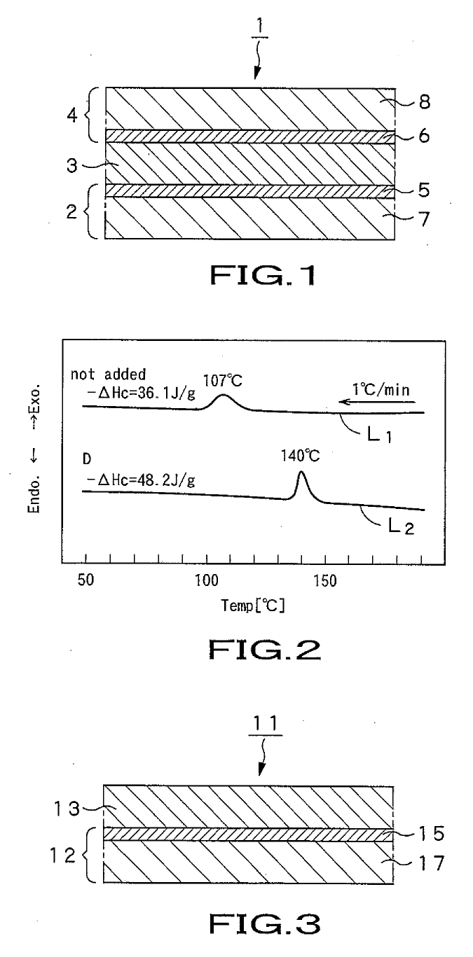

Referring to FIG. 1, the anisotropic electrically conductive adhesive film 1 includes a base film 2 as a first peel film having a first peel layer 5, and also includes an adhesive layer 3. This adhesive layer is formed of an anisotropic electrically conductive adhesive material and is provided on the first peel layer 5 of the base film 2. The anisotropic electrically conductive adhesive film also includes a cover film 4 as a second peel film. The cover film is provided on a surface of the adhesive layer 3 opposite to the surface thereof carrying the base film 2 via a second peel layer 6 having a peel force different from that of the first peel layer 5.

The anisotropic electrically conductive adhesive film 1 described here is made up of the adhesive layer 3, base film 2 and the cover film 4. The adhesive layer 3, formed of an anisotropic electrically conductive adhesive material, has its both sides held between the base film 2 and the cover film 4 to form a three-layered structure. It should be noted that the present invention is not limited to this configuration. That is, the present invention may comprise an anisotropic electrically conductive adhesive film of the type in which a peel film is provided only on its one side, viz., the type in which the cover film inclusive of the second peel layer is omitted from the above-described configuration.

The base film 2 as the first peel film is composed of a base material 7 and the first peel layer 5 formed on one side of the base material 7. The base material 7 is a non-contractile biodegradable film composed of a fatty acid polyester component and the first peel layer S is formed by coating a thermosetting silicone resin which is curable at a temperature not lower than 100° C. on the base material 7, followed by curing. Specifically, the first peel layer 5 may be formed by heating to a temperature of the order of 100 to 160° C. To provide the non-contractile biodegradable film, polylactic acid (PLA) that levorotatory (L) lactic acid and dextrorotatory (D) lactic acid (an optical isomer of L polylactic acid) were composed in certain specified proportions may be used as the fatty acid polyester component which is to be the base material 7 of the base film 2. Preferably, the base material 7 of the base film 2 is colored in white or black for ease in viewing, and the first peel layer 5 is of a thickness on the order of 50 to 400 nm.

The cover film 4 as the second peel film is composed of a base material 8 and a second peel layer 6 formed on one side of the base material 8. The base material 8 is a non-contractile biodegradable film composed of a fatty acid polyester component, and the second peel layer 6 is formed by coating a thermosetting silicone resin which is curable at a temperature not lower than 100° C. on the base material 8, followed by curing. Specifically, the second peel layer 6 may be formed by heating to a temperature of the order of 100 to 160° C. The second peel layer 6 is configured to develop a peel force different from that of the first peel layer 5. Specifically, the second peel layer 6 is configured to develop a peel force lower than that of the first peel layer 5. The non-contractile biodegradable film composed of the fatty acid polyester component to be the base material 8 of the cover film 4, may be formed of the same material as that of the base material 7 of the base film 2 described above. It should be noted that the base material 8 of the cover film 4 may be transparent and of the thickness of the order of 10 to 40 μm, with the second peel layer 6 being of the thickness of the order of 50 to 400 nm.

As described above, the base film 2, the base material 7 of which is the non-contractile biodegradable film, composed of polylactic acid which is composed in turn of L polylactic acid and D polylactic acid, is high in non-contractility at elevated temperatures. In similar manner, the cover film 4, the base material 8 of which is the non-contractile biodegradable film, composed of polylactic acid which is composed in turn of L polylactic acid and D polylactic acid is also high in non-contractility at elevated temperatures. It is thus possible to use a thermosetting silicone resin which is curable at a temperature not lower than 100° C., as the material for the peel layer formed on coating and curing on the base materials 7 and 8. By having the first and second peel layers 5, 6 cured at elevated temperatures, it becomes possible to reduce the peel force of the base film 2 and the cover film 4 with respect to the adhesive layer 3, that is, to increase the degree of freedom in selecting the setting values of the peel force.

In addition, the base film 2 and the cover film 4, the base materials 7 and 8 of which are non-contractile biodegradable films formed of polylactic acid which is composed of L polylactic acid and D polylactic acid, can be severed or cut with ease. The peel film by itself may thus be cut to desired shape with ease. In addition, in case of using the base film 2 and the cover film 4 for the anisotropic electrically conductive adhesive film 1, it is possible to improve the sectility of the anisotropic electrically conductive adhesive film when cutting the film to a desired width.

It is now described that when lactic acid composed of L polylactic acid and D polylactic acid is used as a material for the peel film, a resulting peel film is improved in its sectility.

Regarding lactic acid (referred to below sometimes as PLA), there are two forms of an L-form and a D-form. These two are optically active high molecular materials and, moreover, high molecular crystalline materials each having a helical structure. As the fact derived from a variety of experiments, it has been recognized that, in case ca. 3% (wt %) of D-PLA (D polylactic acid) is present based on L-PLA (L polylactic acid), the degree of crystallization is improved in comparison with the case of the peel film formed only L-PLA. This is presumably ascribable to a stereo-complex generated as a result of interaction between L-PLA and D-PLA.

In more specific terms, in a PLA film composed of L-PLA to which has been added 1 to 5 wt % of D-PLA (a mixture of L polylactic acid and D polylactic acid), molecular orientation is promoted in comparison with the case of the conventional PLA. It may be presumed that, during manufacture of a PLA film, the high molecular chain of PLA is oriented along the moving direction of a sheet of a PLA material. That is, during the step of slitting the peel film and the anisotropic electrically conductive adhesive film carrying the peel film thereon, the high molecular chain of the PLA sheet composed of L-PLA added by 1 to 5% of D-PLA is oriented predominantly along the slitting direction. As a result, the PLA sheet may be improved in its sectility in comparison with the conventional PLA sheet.

In more specific terms, it has been recognized that polylactic acid is significantly affected in its performance of crystallization in dependence upon the proportions of L polylactic acid and D polylactic acid as its constituents, annealing conditions, or upon other additives.

Specifically, polylactic acid (PLA) is a dehydtated polycondensate of lactic acid and, as set forth above, there are two optical isomers of lactic acid, namely the L-form isomer and the D-form isomer. The polymers of these are termed L polylactic acid (PLLA) and D polylactic acid (PDLA). The main chain in PLLA has a left or counterclockwise helix, while that in PDLA has a right or clockwise helix. That is, PLLA is a crystalline high molecular material (helical high molecular material) made up of chiral molecules having a helical main chain. It has been clarified that, if PDLA is crystallized with a crystalline high molecular material such as PLLA, the differences in shape of the L and D forms fit one another to form a so-called stereo-complex like puzzle pieces. With the result that the crystals are more densely packed and elevate the melting temperature.

FIG. 2 shows measurement results of DSC in case of cooling the L polylactic acid film, added by 3 wt % of D polylactic acid, at a rate of 1° C./min from a molten state. In FIG. 2, a curve L1 stands for measurement results of an L polylactic acid film not added by D polylactic acid, and a curve L2 stands for measurement results of L polylactic acid film added by D polylactic acid. In the curve L1, −ΔHc=36.1 J/g, and a peak appears in the vicinity of 107° C. In the curve L2, −ΔHc=48.2 J/g, and a peak appears in the vicinity of 140° C. It has been recognized that the crystallization temperature is raised by addition of D polylactic acid, and that the enthalpy of crystallization (ΔHc, peak area) is also increased, as also shown in FIG. 2. This means that crystallization has also been promoted by addition of D polylactic acid. It is observed that comparison of photos of respective films of L polylactic acid not added by D polylactic acid or L polylactic acid added by D polylactic acid, both taken by a polarizing microscope at 140° C. on cooling from the molten states, indicates that there are numerous spherulites in the L polylactic acid added by D polylactic acid. It has been known that L polylactic acid forms a stereo-complex with D polylactic acid. It may thus be presumed that the formation of the stereo-complex contributes to promotion of crystallization.

The stereo PLA obtained on adding 1 to 5 wt % of D polylactic acid to L polylactic acid has a merit not only that it is high in thermal resistance, but also that a shorter molding time than that needed in the case of the conventional system suffices. In more specific terms, commonplace PLA may be molded in three to five minutes, whereas stereo PLA obtained on adding 3 wt % of D polylactic acid with respect to the L polylactic acid may be molded in ca. 30 seconds. The reason that such a short molding time suffices is assumed to reside in the elevated speed of crystallization. That is, crystallization may possibly be promoted by determined arraying patterns of the L-form and the D-form.

It may be presumed that, as the rate of progress in the crystallization is increased, the speed of molecular orientation is also changed. It may be surmised that, in case a film is formed by biaxial stretching, for example, molecular reorientation or re-arraying occurs such that sectility in cutting the adhesive film exhibits anisotropy. This possibly accounts for high sectility of the present adhesive film in comparison with the sectility of plastics films, such as films of polyester or polypropylene.

Thus, the base film 2 and the cover film 4 are peel films each having a crystalline structure composed of L polylactic acid and D polylactic acid. That is, the base material of the base film 2 or the cover film 4 is a non-contractile biodegradable film formed of polylactic acid formed in turn of L polylactic acid and D polylactic acid. If the base film 2 or the cover film 4 is used for the anisotropic electrically conductive adhesive film 1, it is possible to improve the sectility when the anisotropic electrically conductive adhesive film is cut through to a preset width.

The anisotropic electrically conductive adhesive material that composes the adhesive layer 3 is an insulating adhesive in which binder resin as electrically conductive particles are dispersed. As such insulating adhesive, an epoxy resin, a phenoxy resin or an acrylic resin may be used. The adhesive layer is formed to a thickness of the order of 10 to 50 μm.

The anisotropic electrically conductive adhesive film 1, formulated as described above, includes the base film 2 as a first peel film, on one surface of which is provided the first peel layer 5. The anisotropic electrically conductive adhesive film also includes the adhesive layer 3 formed of the anisotropic electrically conductive adhesive material and which is provided on the base film 2 via the first peel layer 5. The anisotropic electrically conductive adhesive film further includes the cover film 4 as a second peel film provided on the second peel layer 6 having a peel force different from that of the first peel layer 5. The cover film 4 is provided on a surface of the adhesive layer opposite to its surface provided with the base film 2 via the second peel layer 6. The base film 2 and the cover film 4 are formed of the base materials 7 and 8, respectively. These base materials 7, 8 are each formed of a non-contractile biodegradable film composed of a fatty acid polyester component. The first and second peel layers 5, 6, each formed of the thermosetting silicone resin, curable at higher than 100° C., are provided on the base materials 7 and 8, respectively. The anisotropic electrically conductive adhesive film, thus formulated, is not deformed when heated to provide the peel layers. In addition, the anisotropic electrically conductive adhesive film has a proper peel force, while being severable with ease. Hence, it is possible to relieve the load otherwise imposed on the global environment with the anisotropic electrically conductive adhesive film 1 according to the present invention by having a peel film formed as a biodegradable film. In addition, the anisotropic electrically conductive adhesive film is designed to cope with intricate machining needs in bonding miniaturized electronic devices together to provide for electrical interconnections of a variety of electronic devices.

Specifically, the present invention relates to the anisotropic electrically conductive adhesive film making use of the biodegradable peel film. The biodegradable fatty acid polyester film so far used predominantly for the anisotropic electrically conductive adhesive film lacks in thermal resistance. Hence, the high temperature drying may not be used for the manufacturing process. A low-temperature curing silicon is thus used, with the result that sufficient peel characteristics may not be obtained. Hence, the anisotropic electrically conductive adhesive film may not be realized with the use of the biodegradable peel film. In light of the above, a biodegradable film that may withstand elevated temperatures, specifically a polylactic acid composed of a specified proportion of L polylactic acid and a specified proportion of D polylactic acid, both of which make up the polylactic acid, is used as a base material. In addition, a certain specified silicone resin is used as the silicone resin composition coated. By using the new thermally resistant bio-plastics as the base material of the peel film, it becomes possible to carry out a curing reaction of the silicone resin at 130° C., which it has not been possible with the conventional system. In this manner, an optimum peel force (0.24 N/5 cm), which compares favorably with the value of 1.00 N/5 cm so far possible with the use of the conventional low temperature curing silicone, may be obtained. Furthermore, electronic devices may provisionally be attached with ease to the anisotropic electrically conductive adhesive film having the thermally resistant biodegradable peel film as the cover film 4 has been peeled to expose the surface of the adhesive layer 3. The reason is that there is no fear that the base material of the base film 2, still bonded to the adhesive layer 3, becomes deformed despite the heat generated at the time of the provisional attachment to an electronic component to be bonded to the adhesive film.

In other words, according to the present invention, the unique crystalline structures of a specified proportion of L polylactic acid and a specified proportion of D polylactic acid (optical isomer of L polylactic acid) both of which make up the polylactic acid give rise to a high thermal resistance not achieved with a polylactic acid. With the use of this polylactic acid as the peel film, the base material is not deformed at the time of the heat treatment and, in addition, is easy to sever. As a result, the performance as the peel film may be shown enough. When used up, the peel film is decomposed into water and carbon dioxide by the microorganisms or degrading enzymes. In disposal of wastes, the peel film may be buried underground for land-filling. If the peel films are burned, the amount of heat generated is only small while no harmful substances such as dioxin are yielded, thus positively reducing the load on the global environment. Based on this finding, the present invention has been brought to completion to combat the aforementioned problems.

The biodegrading performance has been checked for the case of the waste film materials produced in use of the anisotropic electrically conductive adhesive films. It has been found that these waste film materials may be decomposed satisfactorily. The biodegradable film of the present invention is not deleterious to environment because of biodegradation of the waste film materials generated in larger quantities.

The anisotropic electrically conductive adhesive film 1 of the present invention is able to relieve the load otherwise applied to the global environment. In addition, it is not deformed at the time of heating in forming a peel layer, and may develop a proper peel force, while being easy to sever.

With the anisotropic electrically conductive adhesive film 1 according to the present invention, polylactic acid is used as a material of the biodegradable film as a base material of the peel film, such as that for the base film or the cover film. Such polylactic acid used is made up of L polylactic acid and D polylactic acid mixed in a proportion of 1 to 5 wt % of D polylactic acid to 100 wt % of L polylactic acid. Thus the anisotropic electrically conductive adhesive film 1 may be improved in its sectility as its high biodegradability and high thermal resistance are maintained.

The anisotropic electrically conductive adhesive film according to the present invention may be devoid of the cover film 4, that is, may be composed only of the base film and the adhesive layer.

An anisotropic electrically conductive adhesive film 11 formed only by a base film and an adhesive layer as shown in FIG. 3 will now be described.

Referring to FIG. 3, the anisotropic electrically conductive adhesive film 11 according to the present invention includes a base film 12 as a peel film having a peel layer 15, and an adhesive layer 13 formed of an anisotropic electrically conductive adhesive material. The adhesive layer 13 is provided on top of the peel layer 15 of the base film 12.

Like the base film 2 described above, the base film 12 as the peel film is composed of a non-contractile biodegradable film formed of a fatty acid polyester component as a base material 17 and a peel layer 15 formed on a surface of the base material. The peel layer 15 is formed by coating a thermosetting silicone resin curable at a temperature not lower than 100° C. on the base material 17 followed by curing the resin. The specified construction and operation of the base material 17 and the peel layer 15 are the same as those of the base material 7 and the first peel layer 5, and hence are not explained in detail. The adhesive layer 13 is constructed similarly to the adhesive layer 3 described above.

The anisotropic electrically conductive adhesive film 11 constructed as described above is composed of the base film 12 as a peel film and an adhesive layer 13. The base film 12 has the peel layer 15 on its one surface. The adhesive layer 13 formed of an anisotropic electrically conductive adhesive material is provided on the base film 12 via the peel layer 15. The base film 12 is composed of a non-contractile biodegradable film formed of a fatty acid polyester component as the base material 17, and the peel layer 15 which is provided on the base material 17 and formed of a thermosetting silicone resin curable at a temperature not lower than 100° C. The so formed anisotropic electrically conductive adhesive film 11 is not deformed by heat treatment to form the peel layer, and possesses a proper peel force as well as optimum sectility. Hence, it is possible to relieve the load on the global environment with the anisotropic electrically conductive adhesive film 1 according to the present invention by using a biodegradable film as a peel film. In addition, the anisotropic electrically conductive adhesive film is designed to cope with the need to satisfy fine position registration in bonding miniaturized electronic devices needed in providing electrical interconnections of a variety of electronic devices.

The method for manufacturing the anisotropic electrically conductive adhesive film I described above will now be described. The method for manufacturing the anisotropic electrically conductive adhesive film includes a first step of coating a thermosetting liquid silicone resin (referred to below sometimes as a silicone resin liquid) curable at a temperature not lower than 100° C. on two non-contractile biodegradable films. The silicone resin liquid is to be first and second peel layers 5 and 6. The non-contractile biodegradable films are each formed of a fatty acid polyester component and are to be the base material 7 of the base film 2 and the base material 8 of the cover film 4. The method also includes a second step of drying and thermally curing the coated silicone resin liquid at a temperature not lower than 100° C. to form the base film 2 having the first peel layer 5 and the cover film 4 having the second peel layer 6 differing in the peel force from the first peel layer 5. The method also includes a third step of coating an anisotropic electrically conductive adhesive material on the first peel layer 5 of the base film 2 and a fourth step of drying the anisotropic electrically conductive adhesive material to form the adhesive layer 3. The method also includes a fifth step of layering the cover film 4 via the second peel layer 6 on a surface of the adhesive layer 3 opposite to its surface provided with the base film 2, and a sixth step of severing the anisotropic electrically conductive adhesive film obtained by the first to fifth steps to a preset width and take up a resulting film on a reel.

In the first step, thermosetting silicone resin liquids for forming the peel layers 5, 6 are coated on biodegradable films of a crystalline structure of polylactic acid composed of L polylactic acid and D polylactic acid, which biodegradable films are to be the base material 7 of the base film 2 and the base material 8 of the cover film 4.

In the second step, the thermosetting silicone resin liquid coated in the first step is dried and thermally cured at a temperature of, for example 130° C., to generate the base film 2 and the cover film 4. At this time, the coating thickness for the silicone resin coated in the first step and/or the temperature of drying and heat curing in the second step is adjusted to provide for different values of the peel force of the first and second peel layers 5 and 6, more specifically, to provide for the peel force of the second peel layer 6 of the cover film 4 smaller than that of the first peel layer 5 of the base film 2.

In the third step, the anisotropic electrically conductive adhesive material is coated to a preset thickness on the first peel layer 5 of the base film 2 provided in the second step.

In the fourth step, the anisotropic electrically conductive adhesive material coated on the first peel layer 5 of the base film 2 in the third step is dried to form the adhesive layer 3.

In the fifth step, the cover film 4 provided in the second step is layered on the adhesive layer 3 formed in the fourth step. At this time, the base film 2 is arranged via the first peel layer 5 on one side of the adhesive layer 3, and the cover film 4 is arranged via the second peel layer 6 on the opposite side of the adhesive layer 3. By this fifth step, the base film 2, adhesive layer 3 and the cover film 4 are unified together to provide a so-called three-layer structure. Stated differently, the above-described first to fifth steps provides an anisotropic electrically conductive adhesive film 1 of the five-layered structure made up of the base material 7 of the base film 2, first peel layer 5, adhesive layer 3, second peel layer 6 and the base material 8 of the cover film 4, sequentially layered in this order.

In the sixth step, the anisotropic electrically conductive adhesive film 1 obtained by the first to fifth steps is cut through to a preset width and taken up on for example a reel to provide a roll of the anisotropic electrically conductive adhesive film 1.

The method for manufacturing the anisotropic electrically conductive adhesive film 1 according to the present invention includes the first to fifth steps as described above. It is thus possible to manufacture the anisotropic electrically conductive adhesive film 1 having the base film 2, the adhesive layer 3 and the cover film 4. The base film 2 includes the first peel layer 5 on its one surface, and the adhesive layer 3 formed of the anisotropic electrically conductive adhesive material is provided on the base film 2 via the first peel layer 5. The cover film 4 as the second peel film is provided on the surface of the adhesive layer 3 opposite to its base film side via the second peel layer 6. The second peel layer 6 provided on one surface of the cover film 4 has a value of the peel force different from that of the first peel layer 5. That is, the base materials of the anisotropic electrically conductive adhesive film 1 are the base film 2 and the cover film 4 each of which is a non-contractile biodegradable film formed of a fatty acid polyester component. The peel layers formed of thermosetting silicone resins are provided on top of the base materials. The anisotropic electrically conductive adhesive film thus prepared is not be deformed on heating carried out to provide the peel layers, and possesses proper peel force as well as optimum sectility.

In manufacturing the anisotropic electrically conductive adhesive film 11, the base film 12 is prepared by the steps similar to first to third steps of the above-described method for manufacturing the anisotropic electrically conductive adhesive film 1. An anisotropic electrically conductive adhesive is then applied to the peel layer 15 of the base film 12. The adhesive is then dried to form the adhesive layer 13, and a step similar to the above-described sixth step is carried out. Further detailed explanation is here dispensed with.

The operation in providing for anisotropic electrically conductive interconnection with the use of the above-described anisotropic electrically conductive adhesive film 1 is now described. Specifically, a substrate and an electronic component to be connected thereto are bonded together as they are kept in an electrically conducting state to each other.

Initially, the cover film 4 is peeled from the adhesive layer 3 to expose the surface of the adhesive layer 3 and a bonding surface of a substrate is pressured onto the exposed surface of the adhesive layer 3.

The bonding force between the adhesive layer 3 bonded to the substrate and the first peel layer 5 of the base film 2 is selected to be smaller than the bonding force between the adhesive layer 3 and the substrate or that between the first peel layer 5 and the base material 7. Thus, if an attempt is made to peel the base material 7 from the substrate the adhesive layer 3 is bonded to, peel occurs on an interface between the first peel layer 5 and the adhesive layer 3. That is, the first peel layer 5 is peeled along with the base material 7 while only the adhesive layer 3 is left on the substrate.

This adhesive layer 3 is held between the substrate and the electronic component being bonded. A resulting assembly is pressured together under heating to bond the substrate and the electronic component together having electrical conductivity.

### EXAMPLE

An Example 1 of a peel film used in an anisotropic electrically conductive adhesive film of the present invention is explained in detail. This Example, however, is not interpreted to be restricting the present invention. In the following, Comparative Examples 1 to 4 are also shown for comparison with Example 1. In the Example 1 and in the Comparative Examples 1 to 4, respective peel film samples were manufactured in a manner as now described. Measurements and evaluation were then made of the initial peel force, initial residual adhesion ratio, the peel force of the anisotropic electrically conductive film, thermal resistance, biodegradability and sectility, as now described.

In Example 1, 7 parts by weight of a 30% addition reaction silicone solution (manufactured by Shin-Etsu Chemical Co., Ltd. under the trade name of KS-847), 0.07 part by weight of a platinum curing catalyst (manufactured by Shin-Etsu Chemical Co., Ltd. under the trade name of PL-50T), 53 parts by weight of toluene and 40 parts by weight of methylethylketone (MEK), were mixed together homogeneously to prepare a composition of a peel agent that is to form the peel layer.

The obtained composition of a releasing agent coat as a base material for the peel film on a surface of a non-contractile biodegradable film composed of polylactic acid composed in turn of L polylactic acid and D polylactic acid to a dry thickness of 0.1 μm by using a coil bar. A resulting assembly was charged into an oven at 130° C. After kept at this temperature for one minute, the assembly was taken out of the oven to yield a peel film made up of a base material for a peel film on one side of which was formed a peel layer. The non-contractile biodegradable film, sometimes referred to below as “new thermally resistant bioplastic film”, is the base material of the peel film and has a thickness of 50 μm.

### <Initial Peel Force>

The initial peel force was measured as follows: An acrylic adhesive tape (manufactured by Sony Chemicals Corporation under the trade name of T4090) was bonded to a surface of the peel film prepared as described above. A resulting product was cut through to a strip shape 200 mm long and 50 mm wide. A load of 2 kg was set on the strip-shaped sample and aged in this state at 70° C. for 20 hours. After the end of the ageing, the sample was put to a T peel test at 25° C. to measure the initial peel force (N/5 cm) using a peel strength tester (manufactured by Orientec under a trade name of Tensilon). It should be noted that, in a peel force test, similar results are obtained without dependency on whether an acrylic adhesive tape or an anisotropic electrically conductive adhesive material is used.

### <Initial Residual Adhesion Ratio>

In measuring the initial residual adhesion ratio, the acrylic adhesive tape peeled by the aforementioned testing of the initial peel force was bonded by a hand roller on a smooth stainless steel plate. The peel force between the acrylic adhesive tape and the stainless steel plate was measured in the same manner as described above (residual peel force).

Apart from this testing, an unused acrylic adhesive tape was bonded by a hand roller on a smooth stainless steel plate, and the peel force between the unused acrylic adhesive tape and the stainless steel plate was measured in the same way as described above (reference peel force). The initial peel adhesion ratio (%) was calculated as the ratio of the residual peel force to the reference peel force.

### <Peel Force of Anisotropic Electrically Conductive Film>

In measuring the peel force of an anisotropic electrically conductive film, an anisotropic electrically conductive film ADH (a reactive adhesive liquid containing an epoxy-based curing agent) was coated on one surface of the peel film obtained as described above. A resulting assembly was kept for one minute in an oven maintained at 80° C. to remove the solvent. Then, an acrylic adhesive film tape (PP tape manufactured by NITTO denko kk) was bonded to the anisotropic electrically conductive film ADH coated on the peel film as described above. A resulting assembly was cut to a strip shape 200 mm long and 50 mm wide and put to a T peel test at 25° C. to measure the initial peel force (N/5 cm) using a peel strength tester (manufactured by Orientec under a trade name of Tensilon).

### <Evaluation of Thermal Resistance>

To evaluate the thermal resistance, whether or not the adhesive film was deformed by thermal curing to form the peel layer was checked by measuring the size of the peel film obtained and by visual inspection.

### <Evaluation of Biodegradability>

The peel film produced was buried in compost and treated at 80° C. for seven days. It was then visually checked whether or not the peel film is biodegradable (see JISK6953 (ISO14855)).

### <Evaluation of Sectility>

In evaluating the sectility, an anisotropic electrically conductive adhesive film obtained on forming an adhesive layer of an anisotropic electrically conductive adhesive material on the peel film obtained was used. This adhesive film was severed to a desired width and its cross-section was visually checked as to the state of cutting marks or state of the sectioned surface, and as to the possible presence of paper debris (powders produced on cutting). The anisotropic electrically conductive adhesive film severed was taken up on a reel or the like to form a roll, and the cross-section of the film of the produced roll was inspected to check for sectility, that is, to check whether or not the roll can be cut with ease.

Comparative Examples 1 to 4 for comparison with Example 1 are now described.

In Comparative Example 1, an experiment was conducted in a manner similar to Example 1 except using a commonplace polylactic acid film 50 μm thick as a base material in place of a new thermally resistant bioplastic film.

In Comparative Example 2, an experiment was conducted in a manner similar to Example 1 except using a commonplace polylethylene terephthalate film 50 μm thick as a base material in place of the new thermally resistant bioplastic film.

In Comparative Example 3, an experiment was conducted in a manner similar to Example 1 except using a commonplace polyethylene naphthalate film 50 μm thick as a base material in place of the new thermally resistant bioplastic film.

In Comparative Example 4, an experiment was conducted in a manner similar to Example 1, except using a polypropylene film 50 μm thick as a base material in place of the new thermally resistant bioplastic film.

Table 1 shows measurement results of the initial peel force, initial residual adhesion ratio and the peel force of the anisotropic electrically conductive film for the peel films of the Example 1 and the Comparative Examples 1 to 4. Table 1 also shows the results of evaluation of the thermal resistance, biodegradability and sectility of the peel films. In Table 1, the figures encircled in parentheses ( ) denote that the figures in question may not be reliable due to e.g. deformed states.

TABLE 1

| | Nos. | | | | |
|---|---|---|---|---|---|
| | | Comp. | Comp. | Comp. | Comp. |
| | Ex. 1 | Ex. 1 | Ex. 2 | Ex. 3 | Ex. 4 |
| Initial Peel | 0.24 | (0.26) | 0.25 | 0.25 | 0.28 |
| Force (N/5 cm) | | | | | |
| Initial Residual | 97 | (96) | 98 | 95 | 96 |
| Adhesion Ratio (%) | | | | | |
| Peel Force of | 0.32 | (0.26) | 0.28 | 0.30 | 0.34 |
| Anisotropic | | | | | |
| Electrically | | | | | |
| Conductive Film | | | | | |
| (N/5 cm) | | | | | |
| Thermal | OK | De- | OK | OK | De- |
| Resistance | | formed | | | formed |
| Biodegradability | OK | OK | NG | NG | NG |
| Sectility | Excel- | NG | Good | Relatively | NG |
| | lent | | | Poor | |

It may be confirmed that, in Comparative Examples 1 and 4, the peel films obtained were deformed, whereas, in Example 1 of the present invention, the peel film obtained was not deformed, and exhibited thermal resistance, as shown in Table 1. It may also be confirmed from Table 1 that, in Comparative Examples 2 to 4, the peel film was not biodegradable, whereas, in Example 1 of the present invention, the peel film obtained possessed biodegradability.

Further, in Comparative Examples 1, 3 and 4, optimum sectility was not noticed, whereas, in Example 1, a high sectility was noticed. It was also confirmed that, in Example 1, the sectility was higher than that of the Comparative Example 2 which showed a high sectility.

It is seen from the above Example that the anisotropic electrically conductive adhesive film making use of the peel film of Example 1 may possess high biodegradability if the peel film of Example 1 is used as a base material of a base film or a cover film. Hence, the anisotropic electrically conductive adhesive film relieves the load otherwise imposed on the global environment. In addition, the anisotropic electrically conductive adhesive film is not deformed by heat processing carried out to form the peel layer, and possesses a proper peel force while it may be severed with ease. The anisotropic electrically conductive adhesive film may thus be used in safety in environmental aspects to provide for electrically conductive interconnection for a variety of electronic components.

It should be noted that the present invention is not limited to the embodiments described above with reference of drawings and it will be apparent to those skilled in the art that various modifications, substitutions or the equivalents may be performed without departing from the scope of the invention as defined by the appended claims.

1. (canceled)

2. (canceled)

3. (canceled)

4. (canceled)

5. (canceled)

6. (canceled)

7. A method for manufacturing an anisotropic electrically conductive adhesive film, comprising:
a first step of applying a thermosetting silicone resin liquid, curable at a temperature not lower than 100° C., to provide a peel layer on a non-contractile biodegradable film that is composed of a fatty acid polyester component and that proves to be a base material of a peel film;
a second step of drying and thermally curing said silicone resin liquid at a temperature not lower than 100° C. to provide a peel film having a peel layer;
a third step of applying an anisotropic electrically conductive adhesive material on said peel layer; and
a fourth step of drying said anisotropic electrically conductive adhesive material to form an adhesive layer.

8. The method for manufacturing an anisotropic electrically conductive adhesive film according to claim 7, further comprising:
a step of severing said anisotropic electrically conductive adhesive film obtained by said first to fourth steps to a preset width to take up a resulting film on a reel.

9. A method for manufacturing an anisotropic electrically conductive adhesive film, comprising:
a first step of applying a thermosetting silicone resin liquid, curable at a temperature not lower than 100° C., to provide a first and second peel layer on a non-contractile biodegradable film that is composed of a fatty acid polyester component and that proves to be a base material of a first and second peel film;
a second step of drying and thermally curing said silicone resin liquid at a temperature not lower than 100° C. to form a first peel film having a first peel layer and a second peel film having a second peel layer having a peel force different from that of said first layer;
a third step of applying an anisotropic electrically conductive adhesive material on said first peel layer of said first peel film;
a fourth step of drying said anisotropic electrically conductive adhesive material to form an adhesive layer; and
a fifth step of layering said second peel film via said second peel layer on a surface of said adhesive layer opposite to the surface of said adhesive layer provided with said first peel film.

10. The method for manufacturing an anisotropic electrically conductive adhesive film according to claim 9 further comprising:
a step of cutting the anisotropic electrically conductive adhesive film obtained by said first to fifth steps to a preset width and taking up a resulting film on a reel.

11. The method for manufacturing an anisotropic electrically conductive adhesive film according to claim 7, wherein
said fatty acid polyester component is polylactic acid composed of L polylactic acid and D polylactic acid; and wherein
said D polylactic acid is contained in an amount of 1 to 5 wt % based on the content of L polylactic acid.

12. The method for manufacturing an anisotropic electrically conductive adhesive film according to claim 9, wherein
polylactic acid composed of L polylactic acid and D polylactic acid is used as said fatty acid polyester component, and wherein
said D polylactic acid is mixed in an amount corresponding to 1 to 5 wt % with respect to said L polylactic acid.
